(19) United States
(12) Patent Application Publication
(10) Pub. No.: US 2025/0060534 A1
(43) Pub. Date: Feb. 20, 2025

(54) OPTICAL DEVICE AND METHOD OF MANUFACTURE

(71) Applicant: Taiwan Semiconductor Manufacturing Co., Ltd., Hsinchu (TW)

(72) Inventors: Hsing-Kuo Hsia, Jhubei City (TW); Chen-Hua Yu, Hsinchu (TW); Chih-Hao Yu, Tainan City (TW); Ren-Fen Tsui, Taipei (TW); Jui Lin Chao, New Taipei City (TW)

(21) Appl. No.: 18/451,984

(22) Filed: Aug. 18, 2023

(51) Int. Cl. G02B 6/293; G02B 6/12

(52) U.S. Cl. CPC G02B 6/29338; G02B 6/12007

(57) ABSTRACT

Optical devices and methods of manufacture are presented in which a resonant ring is incorporated with a optical device on an interposer substrate. The material for the resonant ring may be a material that can trigger second order non-linearity in received light or a material that can trigger third order non-linearity without electrical driving mechanisms.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate formation of a first optical package, in accordance with some embodiments.

FIGS. 10A-10B illustrate formation of a resonant cavity die, in accordance with some embodiments.

FIGS. 11A-11B illustrate bonding of the resonant cavity die and the first optical package to an interposer substrate, in accordance with some embodiments.

FIGS. 12A-12B illustrate formation of a resonant cavity within the interposer substrate, in accordance with some embodiments.

FIGS. 13A-13B illustrate usage of a resonant cavity with a laser die, in accordance with some embodiments.

FIGS. 14A-14C illustrate formation of a resonant cavity die with a material that can trigger third order non-linearity without electrical driving mechanisms, in accordance with some embodiments.

FIGS. 15A-15C illustrate incorporation of the material that can trigger third order non-linearity without electrical driving mechanisms into the interposer substrate, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which one or more frequency comb cavities are functionally incorporated with a compact universal photonic engine (COUPE). However, the embodiments presented herein are intended to be illustrative and are not intended to limit the embodiments to the precise descriptions as discussed. Rather, the embodiments discussed may be incorporated into a wide variety of implementations, and all such implementations are fully intended to be included within the scope of the embodiments.

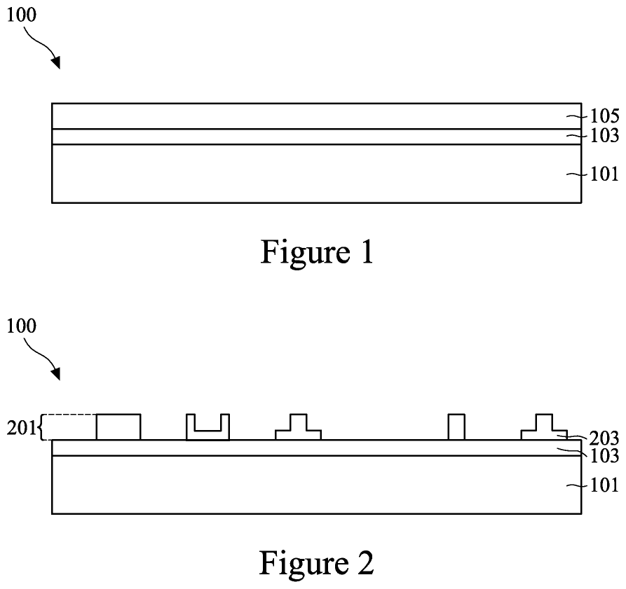

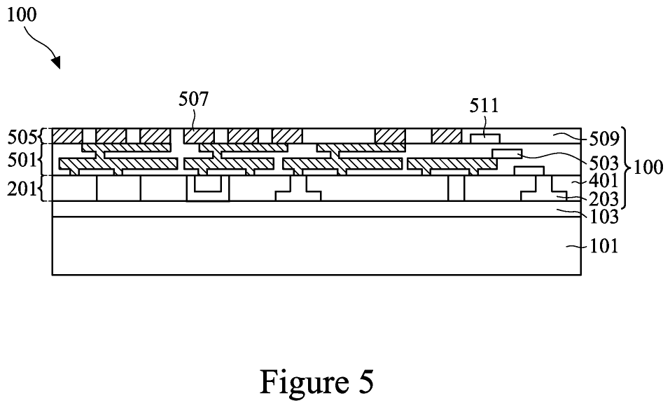

With reference now to FIG. 1, there is illustrated an initial structure of an optical interposer 100 (seen in FIG. 5), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the patterning process may be all or at least most of the manufacturing that is used to form these first optical components 203 components.

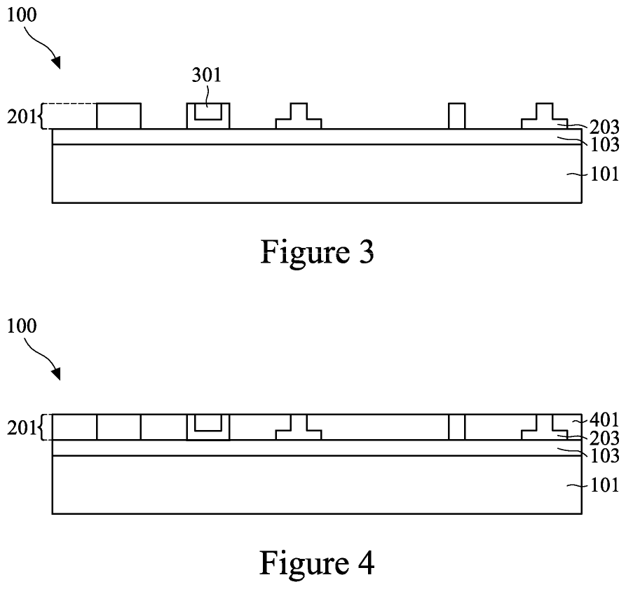

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

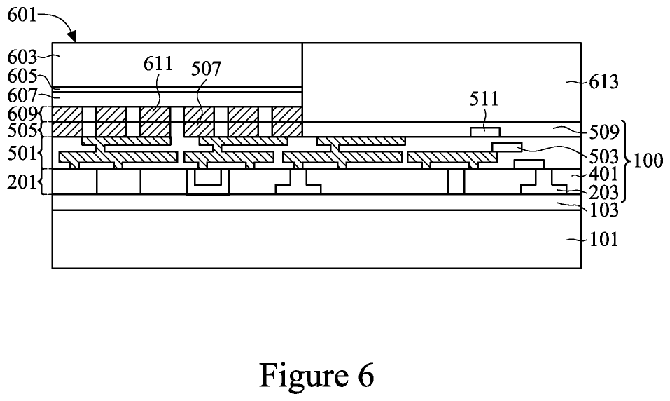

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the laser die 600. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a second gap-fill material 613 is deposited in order to fill the space around the first semiconductor device 601 and provide additional support. In an embodiment the second gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the second gap-fill material 613 has been deposited, the second gap-fill material 613 may be planarized in order to expose the first semiconductor device 601. In an embodiment the planarization process may be a chemical mechanical planarization process, a grinding process, or the like. However, any suitable planarization process may be utilized.

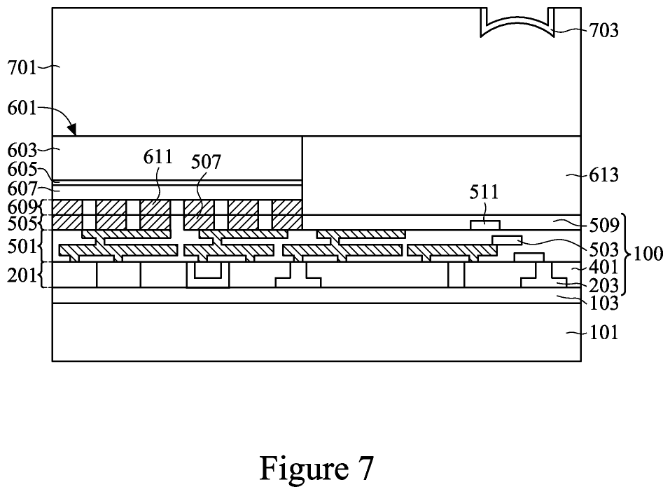

FIG. 7 illustrates an attachment of a support substrate 701 to the first semiconductor device 601 and the second gap-fill material 613. In an embodiment the support substrate 701 may be a support material that is transparent to the wavelength of light that is desired to be used, such as silicon, and may be attached using, e.g., an adhesive (not separately illustrated in FIG. 7). However, in other embodiments the support substrate 701 may be bonded to the first semiconductor device 601 and the second gap-fill material 613 using, e.g., a bonding process. Any suitable method of attaching the support substrate 701 may be used.

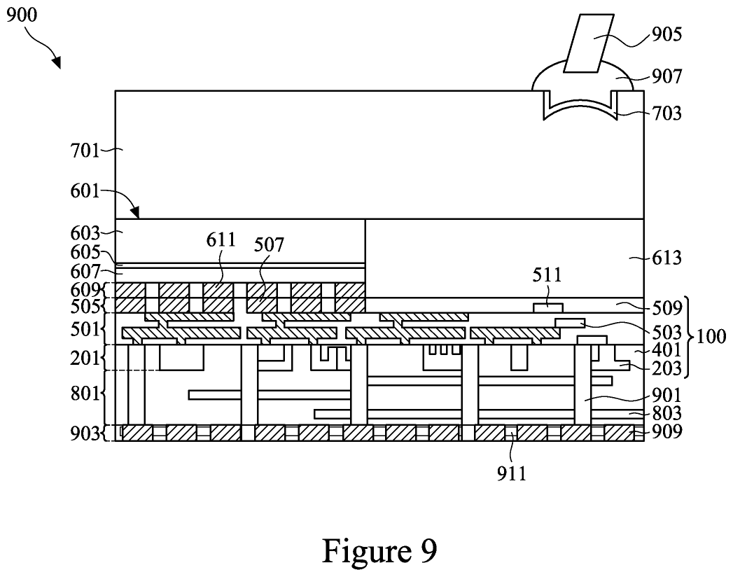

FIG. 7 additionally illustrates the support substrate 701 comprises a coupling lens 703 positioned to facilitate movement from an optical fiber 905 (not illustrated in FIG. 7 but illustrated and described further below with respect to FIG. 9) to a grating coupler within, e.g., the first optical components 203, the second optical components 503 of the first metallization layers 501, or the third optical components 511. In an embodiment the coupling lens 703 may be formed by shaping the material of the support substrate (e.g., silicon) using masking and etching processes. However, any suitable process may be utilized.

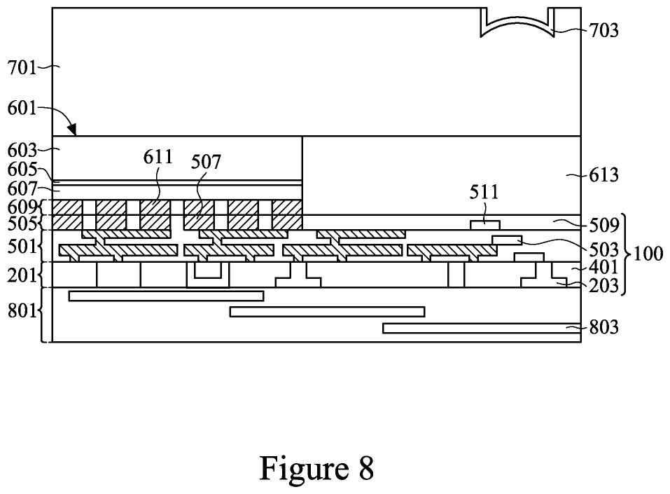

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

FIG. 9 illustrates formation of first through device vias (TDVs) 901, formation of a third bonding layer 903, and placement of an optical fiber 905 to form a first optical package 900. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

Optionally at this point in the process, an optical fiber 905 may be attached. In an embodiment the optical fiber 905 is utilized as an optical input/output port to the optical interposer 100. In an embodiment the optical fiber 905 is placed so as to optically couple the optical fiber 905 and an optical input such as a grating coupler (not separately illustrated in FIG. 9) that is part of the first optical components 203, the second optical components 503, or the third optical components 511. By positioning the optical fiber 905 as such, optical signals leaving the optical fiber 905 are directed towards, e.g., the first active layer 201 of first optical components 203. Similarly, the optical fiber 905 is positioned so that optical signals leaving the first active layer 201 of first optical components 203 is directed into the optical fiber 905 for transmission. However, any suitable location may be utilized.

The optical fiber 905 may be held in place using, e.g., an optical glue 907. In some embodiments, the optical glue 907 comprises a polymer material such as epoxy-acrylate oligomers, and may have a refractive index between about 1 and about 3. However, any suitable material may be utilized.

Additionally, while the optical fiber 905 is illustrated as being attached at this point in the manufacturing process, this is intended to be illustrative and is not intended to be limiting. Rather, the optical fiber 905 may be attached at any suitable point in the process. Any suitable point of attachment may be utilized, and all such attachments at any point in the process are fully intended to be included within the scope of the embodiments.

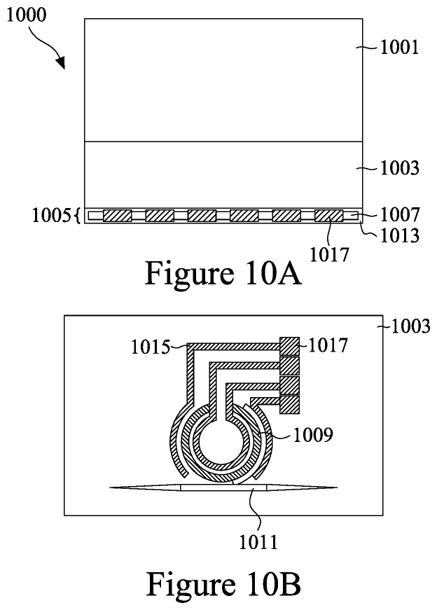

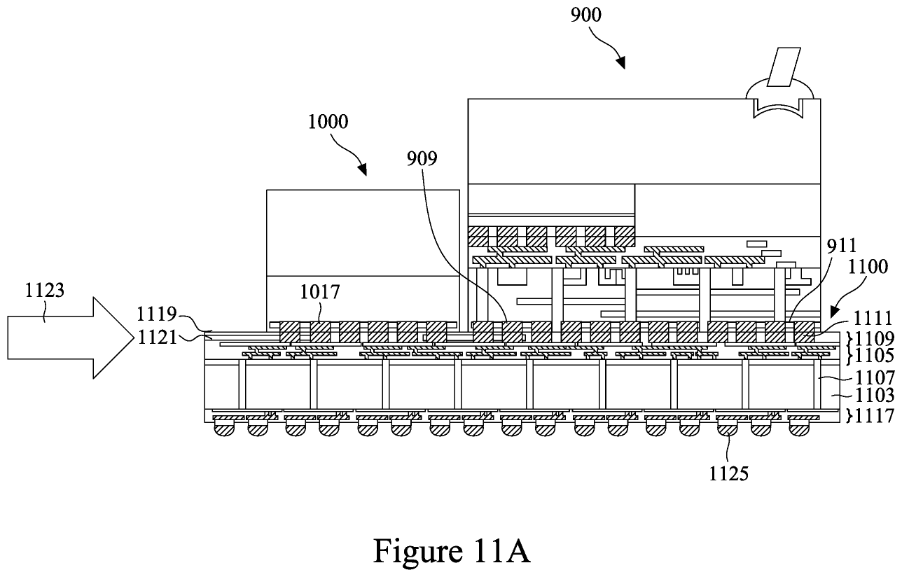

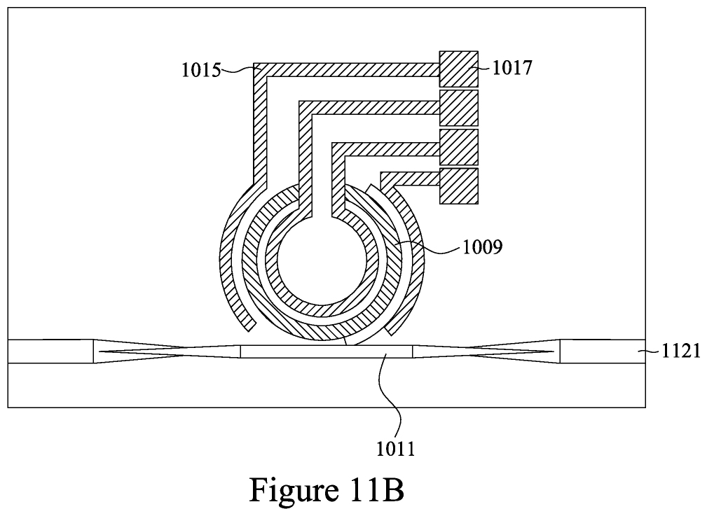

FIGS. 10A-10B (with FIG. 10A being a cross-sectional view and FIG. 10B illustrating a top down view) illustrates a resonant cavity die 1000 that will be used in conjunction with the optical interposer 100 once each device is bonded to an interposer substrate 1100 (not illustrated in FIG. 10A but illustrated and described further below with respect to FIG. 11). In an embodiment the resonant cavity die 1000 comprises a resonant cavity that is utilized to receive light from the interposer substrate 1100 and modulate the light before the light is sent to the optical interposer 100. Additionally, while the resonant cavity die 1000 is illustrated and described as having a resonant cavity, the embodiments described herein may also comprise any other suitable optical or electrical devices.

In a particular embodiment the resonant cavity die 1000 comprises a third substrate 1001, a third insulative layer 1003, and a third active layer 1005 of sixth optical components 1007, one of which comprises a resonant cavity. In an embodiment the third substrate 1001 may be similar to the support substrate 701 such as by being a silicon substrate. However, any suitable material may be utilized.

The third insulative layer 1003 may be formed over the third substrate 1001. In an embodiment the third insulative layer 1003 comprises a cladding and/or dielectric material such as silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the third insulative layer 1003 has been deposited, the material may be planarized using, e.g., a chemical mechanical polishing process in order to planarize a top surface of the third insulative layer 1003. However, any suitable material and method of manufacture may be used.

The third active layer 1005 of the sixth optical components 1007 are formed over the third insulative layer 1003. In an embodiment the third active layer 1005 of the sixth optical components 1007 comprises a resonant cavity such as a cavity ring 1009 with an associated first waveguide 1011 (seen in a top-down view in FIG. 10B) formed from a material that can trigger second order non-linearity in light received from the interposer substrate 1100. In a particular embodiment the material is lithium niobate (LN) formed using a deposition process such as reactive RF sputtering, chemical vapor deposition, pulsed laser techniques, combinations of these, or the like. However, any suitable material and method of deposition may be utilized.

Once the material for the cavity ring 1009 and its associated first waveguide 1011 has been deposited, the material may be patterned into the desired shape for the cavity ring 1009 (e.g., a ring). In an embodiment the material may be patterned using a photolithographic masking and etching process to form the ring shape. However, any suitable method may be utilized.

Additionally, once the cavity ring 1009 and its associated first waveguide 1011 has been formed, or prior to the formation of the cavity ring 1009 and its associated first waveguide 1011, other optical devices of the third active layer 1005 of the sixth optical components 1007 may be formed. In an embodiment the other optical devices may be similar to and manufacturing similarly to the fifth optical components 911 (described above with respect to FIG. 9). However, any suitable devices and methods of manufacture may be utilized.

Once the cavity ring 1009 and the first waveguide 1011 have been formed, the cavity ring 1009 and the first waveguide 1011 may be covered using a cladding layer 1013. In an embodiment the cladding layer 1013 may be a cladding material such as silicon oxide, silicon nitride, germanium oxide, germanium nitride, combinations of these, or the like, formed using a deposition method such as chemical vapor deposition, atomic layer deposition, physical vapor deposition, combinations of these, or the like. However, any suitable material may be utilized.

Once the cladding layer 1013 has been formed, electrodes 1015 are formed to help generate the desired electric field around the cavity ring 1009. In an embodiment the electrodes 1015 may be formed using similar materials and processes as the first metallization layers 501 (described above with respect to FIG. 5) such as, for example, a damascene or dual damascene process. However, any suitable methods and materials may be utilized.

Once the electrodes 1015 have been formed, fourth bond pads 1017 are formed at least partially within the cladding layer 1013 in order to provide material for subsequent bonding process. In an embodiment the fourth bond pads 1017 may be formed using similar materials and similar processes as the first bond pads 507 (described above with respect to FIG. 5).

FIG. 10B illustrates the top down view of the cavity ring 1009, the first waveguide 1011, the electrodes 1015, and the fourth bond pads 1017. As can be seen in this view, the first waveguide 1011 is positioned to receive light and couple the light into and out of the cavity ring 1009. Additionally, the electrodes 1015 are positioned to provide the desired electric field around the material of the cavity ring 1009 (e.g., lithium niobate) in order to modulate the light within the cavity ring 1009, and the fourth bond pads 1017 provide connection between the electrodes 1015 and subsequently bonded devices.

FIG. 11A illustrates that, once the first optical package 900 and the resonant cavity die 1000 have been manufactured, the first optical package 900 and the resonant cavity die 1000 may be attached to an interposer substrate 1100 that is used to couple the first optical package 900 and the resonant cavity die 1000 with other devices to form, for example, a chip-on-wafer-on-substrate (CoWoS®). In an embodiment the interposer substrate 1100 comprises a semiconductor substrate 1103, third metallization layers 1105, second through device vias (TDVs) 1107, and a fourth bonding layer 1109 with fourth bond pads 1111. The semiconductor substrate 1103 may comprise bulk silicon, doped or undoped, or an active layer of a silicon-on-insulator (SOI) substrate. Generally, an SOI substrate comprises a layer of a semiconductor material such as silicon, germanium, silicon germanium, SOI, silicon germanium on insulator (SGOI), or combinations thereof. Other substrates that may be used include multi-layered substrates, gradient substrates, or hybrid orientation substrates.

Optionally, first active devices (not separately illustrated) may be added to the semiconductor substrate 1103. The first active devices comprise a wide variety of active devices and passive devices such as capacitors, resistors, inductors and the like that may be used to generate the desired structural and functional requirements of the design for the semiconductor substrate 1103. The first active devices may be formed using any suitable methods either within or else on the semiconductor substrate 1103.

The third metallization layers 1105 are formed over the semiconductor substrate 1103 and the first active devices and are designed to connect the various active devices to form functional circuitry. In an embodiment the third metallization layers 1105 are formed of alternating layers of dielectric (e.g., low-k dielectric materials, extremely low-k dielectric material, ultra low-k dielectric materials, combinations of these, or the like) and conductive material and may be formed through any suitable process (such as deposition, damascene, dual damascene, etc.). However, any suitable materials and processes may be utilized.

Additionally, at any desired point in the manufacturing process, the second TDVs 1107 may be formed within the semiconductor substrate 1103 and, if desired, one or more layers of the third metallization layers 1105, in order to provide electrical connectivity from a front side of the semiconductor substrate 1103 to a back side of the semiconductor substrate 1103. In an embodiment the second TDVs 1107 may be formed by initially forming through device via (TDV) openings into the semiconductor substrate 1103 and, if desired, any of the overlying third metallization layers 1105 (e.g., after the desired third metallization layer 1105 has been formed but prior to formation of the next overlying third metallization layer 1105). The TDV openings may be formed by applying and developing a suitable photoresist, and removing portions of the underlying materials that are exposed to a desired depth. The TDV openings may be formed so as to extend into the semiconductor substrate 1103 to a depth greater than the eventual desired height of the semiconductor substrate 1103.

Once the TDV openings have been formed within the semiconductor substrate 1103 and or any third metallization layers 1105, the TDV openings may be lined with a liner. The liner may be, e.g., an oxide formed from tetraethylorthosilicate (TEOS) or silicon nitride, although any suitable dielectric material may be used. The liner may be formed using a plasma enhanced chemical vapor deposition (PECVD) process, although other suitable processes, such as physical vapor deposition or a thermal process, may be used.

Once the liner has been formed along the sidewalls and bottom of the TDV openings, a barrier layer may be formed and the remainder of the TDV openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer, filling and overfilling the TDV openings. Once the TDV openings have been filled, excess liner, barrier layer, seed layer, and first conductive material outside of the TDV openings may be removed through a planarization process such as chemical mechanical polishing (CMP), although any suitable removal process may be used.

Once the TDV openings have been filled, the semiconductor substrate 1103 may be thinned until the second TDVs 1107 have been exposed. In an embodiment the semiconductor substrate 1103 may be thinned using, e.g., a chemical mechanical polishing process, a grinding process, or the like. Further, once exposed, the second TDVs 1107 may be recessed using, e.g., one or more etching processes, such as a wet etch process in order to recess the semiconductor substrate 1103 so that the second TDVs 1107 extend out of the semiconductor substrate 1103.

Once the second TDVS 1107 have been exposed, a fourth metallization layer 1117 may be formed in electrical connection with the second TDVs 1107. In an embodiment the fourth metallization layer 1117 may be formed using similar methods and materials as the third metallization layers 1105. However, any suitable method and material may be utilized.

In an embodiment first external connectors 1125 may be placed on the fourth metallization layer 1117 in electrical connection with the second TDVs 1107 and may be, e.g., a ball grid array (BGA) which comprises a eutectic material such as solder, although any suitable materials may be used. In an embodiment in which the first external connectors 1125 are solder bumps, the first external connectors 1125 may be formed using a ball drop method, such as a direct ball drop process. In another embodiment, the solder bumps may be formed by initially forming a layer of tin through any suitable method such as evaporation, electroplating, printing, solder transfer, and then performing a reflow in order to shape the material into the desired bump shape. Once the first external connectors 1125 have been formed, a test may be performed to ensure that the structure is suitable for further processing.

A fourth bonding layer 1109 is formed over the third metallization layers 1105. In an embodiment the fourth bonding layer 1109 may comprise a third dielectric material 1119 and the fourth bond pads 1111 and may be formed using similar materials and similar processes as the first bonding layer 505 (described above with respect to FIG. 5). However, any suitable materials and any suitable methods may be utilized.

Additionally, seventh optical components 1121 are formed within the fourth bonding layer 1109. In an embodiment the seventh optical components 1121 are formed using similar materials (e.g., silicon nitride) and suitable methods (deposition and patterning) as the third optical components 511, described above in FIG. 5. For example, the seventh optical components 1121 may comprise waveguides formed using silicon nitride in order to provide connections between the first optical package 900 and the resonant cavity die 1000. However, any suitable devices, methods, and methods may be utilized.

Once the interposer substrate 1103 has been formed, the first optical package 900 and the resonant cavity die 1000 may be attached to the interposer substrate 1100. In an embodiment the first optical package 900 and the resonant cavity die 1000 may be attached to the interposer substrate 1100 using a dielectric-to-dielectric and metal-to-metal bonding process, similar to the process described above with respect to FIG. 6. For example, surfaces of the first optical package 900, the resonant cavity die 1000, and the interposer substrate 1100 are activated, the third bond pads 909 and the fourth bond pads 1017 are aligned and placed in contact with the fourth bond pads 1111 of the interposer substrate 1100, and the bonds are strengthened using subsequent annealing and pressure. However, any suitable bonding process may be utilized.

FIG. 11B illustrates a top down view of the relationship between the cavity ring 1009, its associated first waveguide 1011, and the seventh optical components 1121 (e.g., a second waveguide) located within the interposer substrate 1100, wherein certain features have been removed from this figure for clarity of the relationship. As can be seen in FIG. 11B, the first waveguide 1011 is in optical connection and helps to optically connect the interposer substrate 1100 to the cavity ring 1009. As such, the cavity ring 1009 can be used to receive light from the interposer substrate 1100, modulate the received light (based on the electrical field applied by the electrodes 1015), and then send the light back to the interposer substrate 1100.

In operation, the interposer substrate 1100 will receive light (represented in FIG. 11A by the arrow labeled 1123, and direct the light into waveguides (of, e.g., the seventh optical components 1121). The seventh optical components 1121 will couple the light in the first waveguide 1011 (within the resonant cavity die 1000) which will couple the light into the cavity ring 1009. The electrodes 1015 are controlled to modulate the light as it goes through the cavity ring 1009, and then couple the modulated light back into the first waveguide 1011. The first waveguide 1011 then couples the modulated light back into the waveguides of the seventh optical components 1121. The seventh optical components 1121 can then route the modulated light to the first optical package 900, where the light will be coupled to the fifth optical components 911 and, from there, throughout the first optical package 900.

By forming the cavity ring 1009 on the resonant cavity die 1000 and then bonding the resonant cavity die 1000 onto the interposer substrate 1100, the resonant cavity die 1000 can be integrated with the first optical package 900 in a realizable format and without problems such as improper alignment with a laser die. As such, the first optical package 900 can be equipped with a frequency comb generation source using reliable processes that do not shorten the life of product operation.

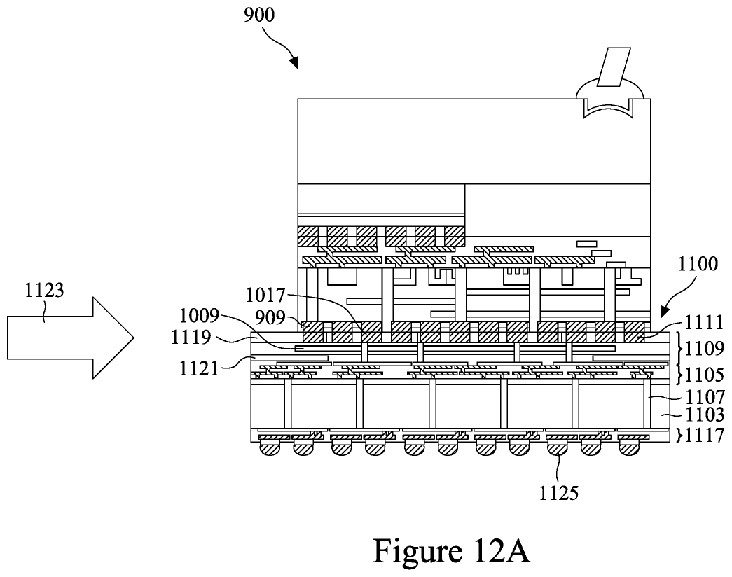

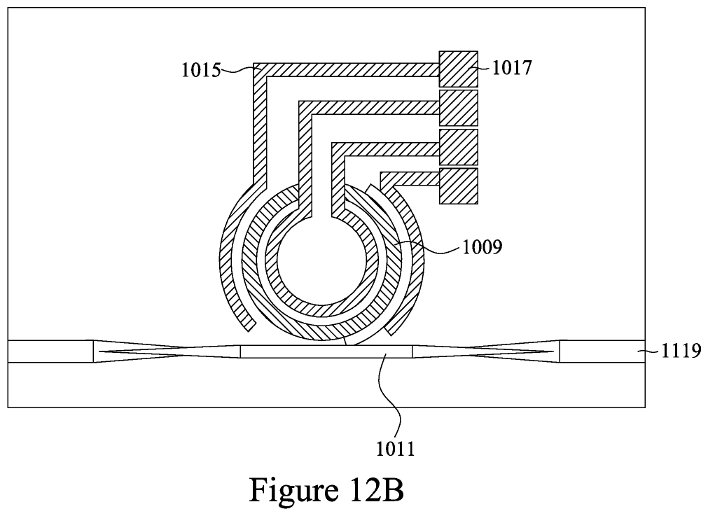

FIGS. 12A-12B illustrate a cross-sectional (FIG. 12A) and a top-down view (FIG. 12B) of another embodiment in which the cavity ring 1009, instead of being manufactured within the resonant cavity die 1000, is formed within the interposer substrate 1100, such as by being formed as one of the seventh optical components 1121. In such an embodiment the cavity ring 1009 is formed, for example, as a part of the fourth bonding layer 1109 using similar processes and materials as described above with respect to FIGS. 10A-10B. For example, before or after the other seventh optical components 1121 have been formed within the fourth bonding layer 1109, the material for the cavity ring 1009 (e.g., lithium niobate) is deposited and patterned. Once all of the seventh optical components 1121 along with the cavity ring 1009 have been formed, the third dielectric material 1119 may be deposited, the electrodes 1015 are formed, and the fourth bond pads 1111 (and any desired vias to connect the fourth bond pads 1111 to the underlying third metallization layers 1105) and fifth bond pads 1115 are simultaneously formed. However, any suitable methods and materials may be utilized.

Once the cavity ring 1009, electrodes 1015, and fourth bond pads 1017 have been formed, the first optical package 900 may be bonded to the fourth bonding layer 1109. In a particular embodiment the first optical package 900 may be bonded as described above with respect to FIG. 11A, such as a dielectric-to-dielectric and metal-to-metal bond. In this embodiment, however, the third bond pads 909 of the first optical package 900 are not just bonded to the fifth bond pads 1115 (of the interposer substrate 1100) but are also bonded to the fourth bond pads 1017 (located in this embodiment in the interposer substrate 1100). However, any suitable bonding process may be utilized.

By manufacturing the cavity ring 1009 within the fourth bonding layer 1109, all of the benefits of using the cavity ring 1009 may be obtained without the use of a separate die (e.g., the resonant cavity die 1000). As such, a separate bonding process for the resonant cavity die 1000 may be avoided while also allowing for the overall size of the device to be reduced.

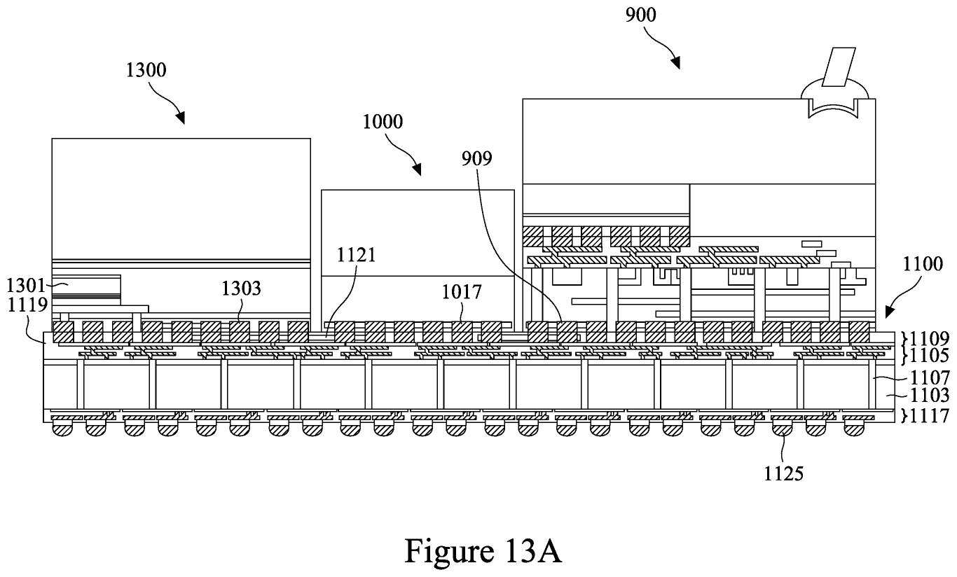

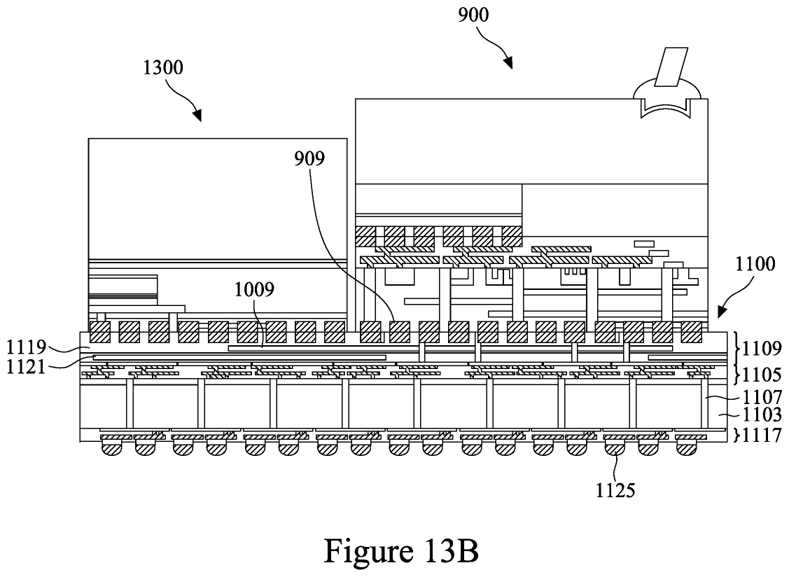

FIG. 13A illustrates yet another embodiment in which the resonant cavity die 1000 is bonded along with the first optical package 900 to the interposer substrate 1100 (similar to the embodiment illustrated in FIG. 11 above). In this embodiment, however, a laser die 1300 is additionally bonded to the interposer substrate 1100 to provide a power source for the optical devices instead of the interposer substrate 1100 receiving light from outside. In some embodiments, the laser die 1300 may comprise light generating structures such as one or more laser diodes 1301 surrounded by dielectric and/or cladding material over a substrate. In particular embodiments the laser diodes may be Fabry-Perot Diodes, and may be based on III-V materials, II-VI materials, or any other suitable set of materials.

In a particular embodiment the one or more laser diodes 1301 may comprise a first contact, a first buffer layer, a first active diode layer comprising multiple quantum wells (MQWs), a second buffer layer, and a second contact (only some of which are illustrated in FIG. 13A for clarity) in order to generate the desired light. Additionally, the generated light may be output from the laser die 1300 through, e.g., the first contact and associated waveguides. However, any suitable structures may be utilized in order to form the one or more laser diodes 1301 and generate the desired light.

Additionally, the laser die 1300 may also comprise second external connectors 1303. In an embodiment the second external connectors 1303 may be similar to the third bond pads 909, such as by being contact pads. However, any suitable materials and shape of connections may also be utilized.

Once the laser die 1300 has been formed and/or otherwise received, the laser die 1300 may be bonded to the interposer substrate 1100. In an embodiment the laser die 1300 may be bonded to the interposer substrate 1100 using a dielectric-to-dielectric and metal-to-metal, similar to the bonding process described above with respect to FIG. 11. However, any suitable bonding process may be utilized.

In this embodiment, instead of receiving light from off of the device, the desired light is generated by the laser die 1300 and coupled into the interposer substrate 1100. The interposer substrate 1100 receives the light and routes the light into the resonant cavity die 1000, where the cavity ring 1009 modulates the light generated by the laser die 1300 and returns the modulated light to the interposer substrate 1100. The interposer substrate 1100 then routes the modulated light to the first optical package 900. In such a fashion, the light can be generated on the first optical package 900 and the resonant cavity die 1000 can be incorporated together with the laser die 1300 and the device receives less light that is generated from off the device (with its associated losses).

FIG. 13B illustrates another embodiment in which the laser die 1300 is bonded to the interposer substrate 1100. In this embodiment, however, the resonant cavity die 1000 is not utilized, and the cavity ring 1009 is formed within the seventh optical components 1121 as part of the interposer substrate 1100. In particular, the cavity ring 1009 is formed within the fourth bonding layer 1109 as described above with respect to FIGS. 12A-12B. However, any suitable manufacturing and materials may be utilized.

Once the cavity ring 1009 has been formed within the fourth bonding layer 1109 of the interposer substrate 1100, the first optical package 900 and the laser die 1300 are bonded to the interposer substrate 1100. In an embodiment the first optical package 900 and the laser die 1300 may be bonded using a dielectric-to-dielectric and metal-to-metal bonding process, such as described above with respect to FIG. 11. However, any suitable bonding process may be utilized.

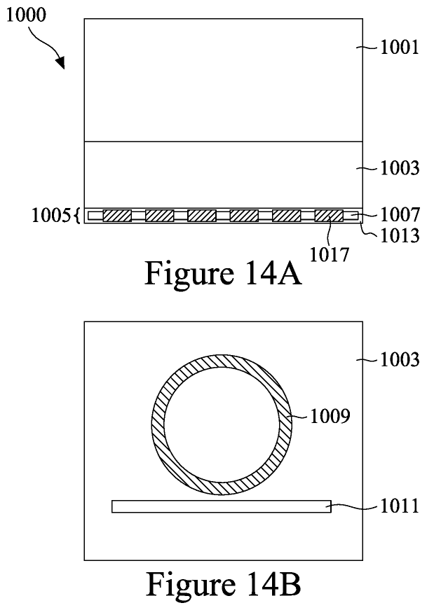

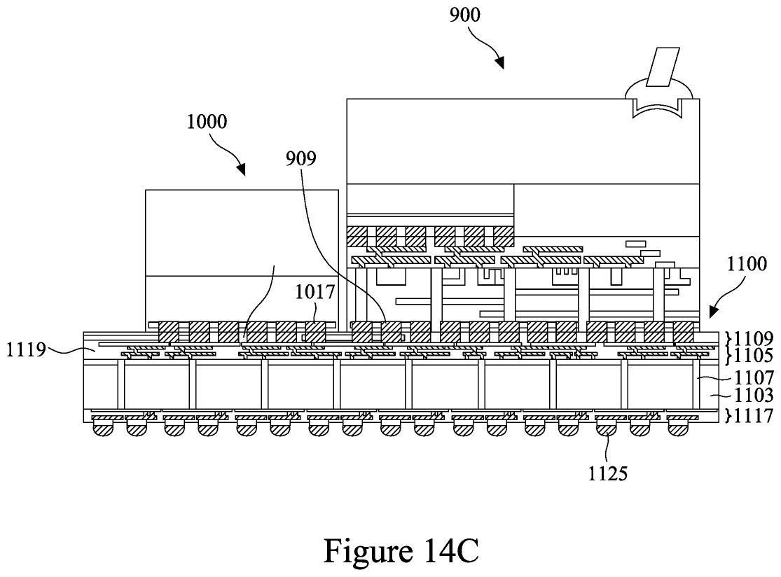

FIGS. 14A-14B illustrates another embodiment of the resonant cavity die 1000. In this embodiment, however, instead of using a material that can trigger second order non-linearity in the received light (such as lithium niobate) for the cavity ring 1009, a material that can trigger third order non-linearity without electrical driving mechanisms (e.g., the electrodes 1015) is utilized. In a particular embodiment the material that can trigger third order non-linearity can be a material such as silicon nitride or the like. However, any suitable material may be utilized.

To initiate the formation of the cavity ring 1009 in this embodiment, the material (e.g., silicon nitride) may be initially deposited using a deposition process such as physical vapor deposition, chemical vapor deposition, atomic layer deposition, combinations of these, or the like. In a particular embodiment the material may be deposited in an amorphous state. However, any suitable material, method, and state may be utilized.

Once the material has been deposited, the material may be patterned into the shape of the cavity ring 1009 (e.g., a ring) and the associated first waveguide 1011. In an embodiment the material may be patterned using a photolithographic masking and etching process. However, any suitable method of patterning may be utilized.

Once the cavity ring 1009 and the associated first waveguide 1011 have been formed, any other desired ones of the optical devices may be formed. In an embodiment the other optical devices may be formed using similar processes and materials as the second optical components 503. However, any suitable processes and materials may be utilized.

Once the cavity ring 1009, associated first waveguide 1011, and any other desired optical devices have been formed, the cladding layer 1013 and the fourth bond pads 1017 may be formed. In an embodiment the cladding layer 1013 and the fourth bond pads 1017 are formed as described above with respect to FIG. 10A. However, any suitable methods and materials may be utilized.

FIG. 14C illustrates that, once the resonant cavity die 1000 has been formed with the material that can trigger third order non-linearity without electrical driving mechanisms (e.g., silicon nitride), the resonant cavity die 1000 is bonded to the interposer substrate 1100 along with the first optical package 900. In an embodiment the resonant cavity die 1000 may be bonded as described above with respect to FIG. 11, such as dielectric-to-dielectric and metal-to-metal bond. However, any suitable bonding process may be utilized.

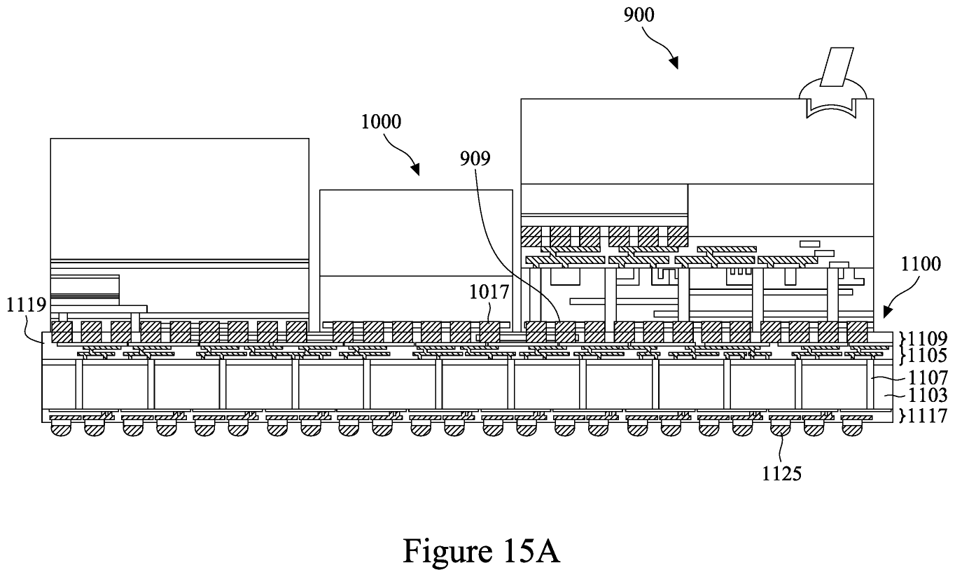

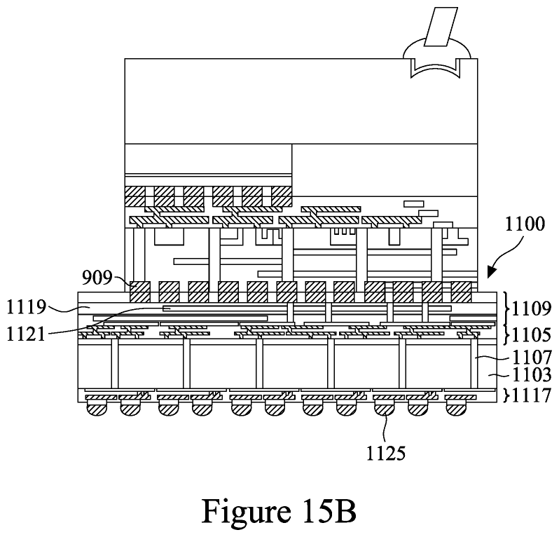

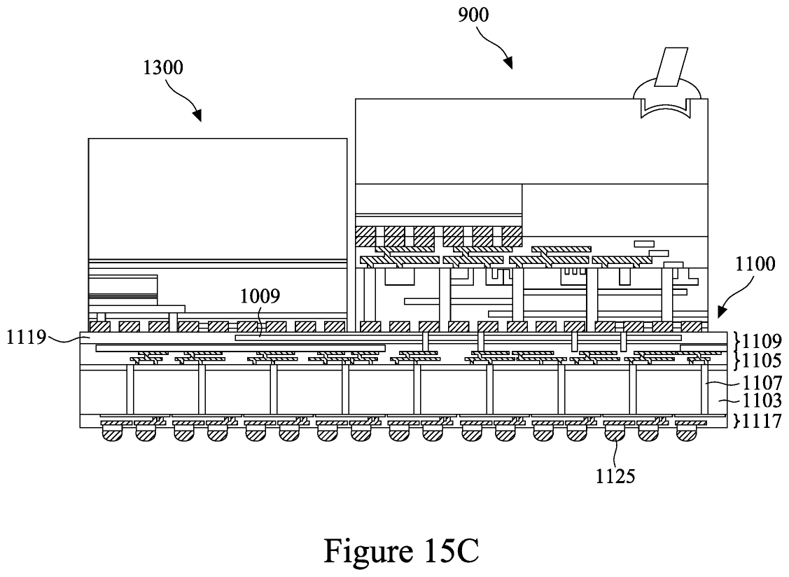

FIG. 15A illustrates another embodiment which utilizes the resonant cavity die 1000 with the material that can trigger third order non-linearity without electrical driving mechanisms (e.g., silicon nitride). In this embodiment the resonant cavity die 1000 and the first optical package 900 are bonded to the interposer substrate 1100 along with the laser die 1300. In an embodiment the laser die 1300 may be bonded to the interposer substrate using, e.g., a dielectric-to-dielectric and metal-to-metal bonding process as described above with respect to FIG. 11. However, any suitable bonding process may be utilized.

FIG. 15B illustrates another embodiment in which the cavity ring 1009 with the material that can trigger third order non-linearity without electrical driving mechanisms (e.g., silicon nitride), instead of being manufactured within the resonant cavity die 1000, is formed as one of the seventh optical components 1121 within the interposer substrate 1100. In such an embodiment the cavity ring 1009 is formed, for example, as a part of the fourth bonding layer 1109 using similar processes and materials as described above with respect to FIGS. 14A-14B. For example, before or after other ones of the seventh optical components 1121 have been formed within the fourth bonding layer 1109, the material for the cavity ring 1009 (e.g., silicon nitride) is deposited and patterned. However, any suitable methods and materials may be utilized.

However, because the material that can trigger third order non-linearity without electrical driving mechanisms may be formed to different thicknesses than other ones of the seventh optical components 1121, the material that can trigger third order non-linearity may be deposited and patterned on a different layer than other ones of the seventh optical components 1121. In other embodiments, the cavity ring 1009 and the rest of the seventh optical components 1121 may be formed in a single layer, whereby the components are formed in sequential manufacturing processes. All such combinations of manufacturing processes steps are fully intended to be included within the scope of the embodiments.

Once the cavity ring 1009 has been formed as one of the seventh optical components, the third bond pads 909 may be formed and the first optical package 900 may be bonded to the fourth bonding layer 1109. In a particular embodiment the third bond pads 909 may be formed as described above with respect to FIG. 9 and the first optical package 900 may be bonded as described above with respect to FIG. 11A, such as a dielectric-to-dielectric and metal-to-metal bond. In this embodiment, however, because the cavity ring 1009 is formed with the material that can trigger third order non-linearity without electrical driving mechanisms, the electrodes 1015 and fourth bond pads 1017 are not formed. As such, the third bond pads 909 of the first optical package 900 are not bonded to the fourth bond pads 1017 (because these are not formed).

FIG. 15C illustrates another embodiment in which the laser die 1300 is bonded to the interposer substrate 1100. In this embodiment, however, the resonant cavity die 1000 is not utilized, and the cavity ring 1009 with the material that can trigger third order non-linearity without electrical driving mechanisms (e.g., silicon nitride) is formed as part of the interposer substrate 1100. In particular, the cavity ring 1009 is formed within the fourth bonding layer 1109 as described above with respect to FIG. 14C. However, any suitable manufacturing and materials may be utilized.

Once the cavity ring 1009 has been formed within the fourth bonding layer 1109 of the interposer substrate 1100, the first optical package 900 and the laser die 1300 are bonded to the interposer substrate 1100. In an embodiment the first optical package 900 and the laser die 1300 may be bonded using a dielectric-to-dielectric and metal-to-metal bonding process, such as described above with respect to FIG. 11. However, any suitable bonding process may be utilized.

By utilizing the structures and methods presented herein, a frequency comb generation architecture can be incorporated into a co-packaging photonics (CPO) construction using, for example, evanescent coupling. Additionally, different materials can be leveraged in the manufacture of the frequency comb generation architecture. As such, a more compact unit with better performance can be obtained.

In an embodiment, a method of manufacturing an optical device includes: forming a resonant ring die; bonding the resonant ring die to an interposer substrate; and bonding a first optical package to the interposer substrate. In an embodiment the resonant ring die comprises a cavity ring, the cavity ring comprising lithium niobate. In an embodiment the resonant ring die comprises a cavity ring, the cavity ring comprising silicon nitride. In an embodiment the silicon nitride comprises amorphous silicon nitride. In an embodiment the bonding the resonant ring die to the interposer substrate uses a dielectric-to-dielectric and a metal-to-metal bond. In an embodiment the forming the resonant ring die further includes: depositing lithium niobate; patterning the lithium niobate into a ring shape; and forming electrodes adjacent to the ring shape. In an embodiment the method further includes bonding a laser die to the interposer substrate.

In another embodiment, a method of manufacturing an optical device including: forming a bonding layer over a semiconductor substrate, the bonding layer including: a cavity ring; and first contact pads; and bonding a first optical package to the first contact pads. In an embodiment the cavity ring comprises lithium niobate. In an embodiment the cavity ring comprises silicon nitride. In an embodiment the cavity ring comprises amorphous silicon nitride. In an embodiment the method further includes bonding a laser die to the first contact pads. In an embodiment the forming the bonding layer further includes: depositing lithium niobate; patterning the lithium niobate into a ring shape; and forming electrodes adjacent to the ring shape. In an embodiment the bonding the first optical package to the first contact pads for dielectric-to-dielectric and metal-to-metal bonds.

In yet another embodiment an optical device includes: a first optical package located over and bonded to an interposer substrate, the interposer substrate comprising a semiconductor substrate; and a cavity ring located over the semiconductor substrate. In an embodiment the cavity ring is located within a bonding layer of the interposer substrate. In an embodiment the cavity ring is located within a cavity resonant die, the cavity resonant die bonded to the interposer substrate. In an embodiment the cavity ring comprises lithium niobate. In an embodiment the cavity ring comprises amorphous silicon nitride. In an embodiment the optical device further includes a laser die bonded to the interposer substrate.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of manufacturing an optical device, the method comprising:
forming a resonant ring die;
bonding the resonant ring die to an interposer substrate; and
bonding a first optical package to the interposer substrate.

2. The method of claim 1, wherein the resonant ring die comprises a cavity ring, the cavity ring comprising lithium niobate.

3. The method of claim 1, wherein the resonant ring die comprises a cavity ring, the cavity ring comprising silicon nitride.

4. The method of claim 3, wherein the silicon nitride comprises amorphous silicon nitride.

5. The method of claim 1, wherein the bonding the resonant ring die to the interposer substrate uses a dielectric-to-dielectric and a metal-to-metal bond.

6. The method of claim 1, wherein the forming the resonant ring die further comprises:
depositing lithium niobate;
patterning the lithium niobate into a ring shape; and
forming electrodes adjacent to the ring shape.

7. The method of claim 1, further comprising bonding a laser die to the interposer substrate.

8. A method of manufacturing an optical device, the method comprising:
forming a bonding layer over a semiconductor substrate, the bonding layer comprising:
a cavity ring; and
first contact pads; and
bonding a first optical package to the first contact pads.

9. The method of claim 8, wherein the cavity ring comprises lithium niobate.

10. The method of claim 8, wherein the cavity ring comprises silicon nitride.

11. The method of claim 10, wherein the cavity ring comprises amorphous silicon nitride.

12. The method of claim 8, further comprising bonding a laser die to the first contact pads.

13. The method of claim 8, wherein the forming the bonding layer further comprises:
depositing lithium niobate;
patterning the lithium niobate into a ring shape; and
forming electrodes adjacent to the ring shape.

14. The method of claim 8, wherein the bonding the first optical package to the first contact pads for dielectric-to-dielectric and metal-to-metal bonds.

15. An optical device comprising:
a first optical package located over and bonded to an interposer substrate, the interposer substrate comprising a semiconductor substrate; and
a cavity ring located over the semiconductor substrate.

16. The optical device of claim 15, wherein the cavity ring is located within a bonding layer of the interposer substrate.

17. The optical device of claim 15, wherein the cavity ring is located within a cavity resonant die, the cavity resonant die bonded to the interposer substrate.

18. The optical device of claim 15, wherein the cavity ring comprises lithium niobate.

19. The optical device of claim 15, wherein the cavity ring comprises amorphous silicon nitride.

20. The optical device of claim 15, further comprising a laser die bonded to the interposer substrate.
